(19) United States
(12) Patent Application Publication
(10) Pub. No.: US 2003/0031933 A1
(43) Pub. Date: Feb. 13, 2003

(54) Solid polymer electrolyte lithium battery

(76) Inventors: Elena M. Shembel, La Spezia (IT); Oleg V. Chervakov, Fort Lauderdale, FL (US); Peter Novak, Antwerp (BE)

Correspondence Address: Gregory A. Nelson, Esq., Akerman, Senterfitt & Eidson, P.A., 222 Lakeview Avenue, Suite 400, P.O. Box 3188, West Palm Beach, FL, 33402-3188, US

(21) Appl. No.: 10/038,556

(22) Filed: Jan. 4, 2002

Related U.S. Application Data
(60) Provisional application No. 60/310,908, filed on Aug. 8, 2001.

(51) Int. Cl. H01M 4/50; H01M 4/60; H01M 10/40

(52) U.S. Cl. 429/316; 429/307; 429/309; 429/213; 429/224; 429/231.3; 429/231.5

(57) ABSTRACT

A polymer electrolyte includes a modified polymeric material, the modified polymeric material including a halogen containing polymer having an enhanced halogen level, the enhanced halogen level relative to a halogen content of the halogen containing polymer formed from polymerization of its monomer. A salt of an alkali metal and an aprotic solvent are also provided. The salt and the aprotic solvent are integrated with the modified polymeric material. The halogen containing polymer is preferably polyvinylchloride (PVC) obtained by emulsion or suspension polymerization of vinylchloride. A method for preparing solid polymer electrolytes includes the steps of providing a halogen containing polymer, halogenating the halogen containing polymer, wherein an enhanced halogen containing modified polymer material results. The enhanced halogen level is relative to the halogen content of the halogen containing polymer formed from polymerization of its monomer. The resulting modified polymer material is then blended together with at least one salt of an alkali metal and at least one aprotic solvent.

### CROSS-REFERENCE TO RELATED APPLICATIONS

This application claims the benefit of U.S. Provisional Application 60/310,908 entitled “SOLID POLYMER ELECTROLYTE LITHIUM BATTERY” filed Aug. 8, 2001, the entirety of which is incorporated herein by reference.

### FIELD OF THE INVENTION

This invention relates generally to an improved solid polymer electrolyte battery. In particular, this invention is related to primary and rechargeable batteries with solid or gel polymer electrolytes.

### BACKGROUND OF THE INVENTION

The demand for new and improved electronic devices such as cellular phones, notebook computers and compact camcorders have demanded energy storage devices having increasingly higher specific energy densities. A number of advanced battery technologies have recently been developed to service these devices, such as metal hydride (e.g., Ni-MH), nickel-cadmium (Ni—Cd), lithium batteries with liquid electrolytes and recently, lithium batteries with polymer electrolytes.

Lithium batteries have been introduced into the market because of their high energy densities. Lithium is atomic number three on the periodic table of elements, having the lightest atomic weight and highest energy density of any solid material. As a result, lithium is a preferred material for batteries, having very high energy density. Lithium batteries are also desirable because they have a high unit cell voltage of up to approximately 4.2 V, as compared to approximately 1.5 V for both Ni—Cd and Ni-MH cells.

Lithium batteries can be either lithium ion batteries or lithium metal batteries. Lithium ion batteries intercalate lithium ions in a host material, such as graphite, to form the anode. On the other hand, lithium metal batteries use metallic lithium or lithium alloys for the anode.

The electrolyte used in lithium batteries can be a liquid or a polymer electrolyte. Lithium batteries having liquid electrolytes have been on the market for several years. Lithium batteries having solid polymer electrolytes are comparatively new entries into the marketplace.

Lithium ion rechargeable batteries and lithium-metal primary batteries having liquid electrolytes are currently mass produced for applications such as notebook computers, camcorders and cellular telephones. However, lithium batteries having liquid electrolyte technology has several major drawbacks. These drawbacks relate to cost, safety, size and packaging and stem from use of a liquid electrolyte. The liquid electrolyte requires packaging in rigid hermetically sealed metal “cans” which can reduce energy density. In addition, for safety reasons, lithium ion rechargeable batteries and lithium-metal primary batteries having liquid electrolytes are designed to vent automatically when certain abuse conditions exist, such as a substantial increase in internal pressure which can be caused by overheating. If the cell is not vented under extreme pressure, it can explode because the liquid electrolyte used in liquid Li cells is extremely flammable.

Lithium batteries having solid polymer electrolytes represent an evolving alternative to lithium batteries having liquid electrolytes. Typical polymer electrolytes include the polyethylene oxide (PEO), polyacrylonitrile (PAN), polymethylmethacrylate (PMMA), polyvinylidine fluoride (PVDF).

The electrochemical operation of a lithium battery is essentially the same whether a liquid electrolyte or polymer electrolyte is used, and is based on the anode and cathode materials used. In the case of a lithium ion battery, the battery works by the rocking chair principle, that is, charging and discharging, allowing lithium ions to “rock” back and forth between cathode and anode and for lithium ions to be involved with the intercalation-deintercalation process on the active electrode material surfaces.

During the cycling of a lithium-metal battery the following process occur. While discharging, lithium dissolution takes place at the metal lithium anode, and results in passing lithium ions into the electrolyte. On the cathode during discharging, intercalation of lithium ions into solid phase occurs. During the charging of lithium-metal battery, lithium cations deintercalate from the solid phase cathode, and the deposition of metal lithium takes place on the metal lithium anode from lithium ions in the nonaqueous liquid electrolyte.

When using a liquid electrolyte the deposition of metal lithium can be followed by dendrite formation, and result in a short circuit in the battery. Short circuits can result in an explosion. In this connection, the cycling of a lithium battery having a liquid electrolyte can be very dangerous. Substitution of a liquid electrolyte in lithium-metal battery by a polymer solid electrolyte prevents the formation of dendrites on metal lithium and prevents short circuits from developing during cycling of the battery.

Because its electrolyte is a non-volatile material which cannot leak, a lithium battery having a polymer electrolyte is intrinsically safer than a lithium battery having a liquid electrolyte. Moreover, polymer electrolytes eliminate the need for venting and package pressure which are generally required for operation of lithium batteries having liquid electrolytes. Thus, polymer electrolytes make it possible to use a soft outer case such as a metal plastic laminate bag, resulting in improvement in weight and thickness, when compared to liquid electrolyte can-type Li batteries. In addition, recent research has indicated that electrode materials react less with polymer electrolytes compared to liquid electrolytes even under abuse conditions. This should constitute a significant safety advantage for stable charging-discharging of Li batteries having polymer electrolytes over conventional Li batteries having liquid electrolytes. Lithium batteries having solid polymer electrolytes are also considered environmentally acceptable.

Lithium batteries having polymer electrolytes are generally configured as gel-type polymer electrolytes which have liquid electrolytes intermixed with a selected polymer electrolyte matrix material. The polymer electrolyte functions as a separator, being interposed between the cathode and anode films of the battery. Each cathode, separator and anode combination forms a unit battery cell. Practical lithium batteries, such as those having polymer electrolytes, are generally prepared by stacking a number of battery cells in series to achieve desired battery capacity.

Lithium metal rechargeable batteries offer improved performance as compared to as compared to Li ion batteries, particularly higher capacity. But while Li metal has been shown to function well in primary batteries, a truly viable, rechargeable Li metal technology has imposed several challenges.

One of the main problems of Li metal batteries is that lithium, in its metallic form, is highly reactive. As such, it presents unique difficulties in rechargeable configurations. Repeated charge/discharge cycles can cause a build-up of surface irregularities on the lithium metal containing electrode. These irregular structures, known as dendrites, can grow to such an extent that they penetrate the separator between positive and negative electrodes and create an internal short circuit. At best, this phenomenon shortens the useful life of a rechargeable Li-metal battery to 150 cycles or less. At worst, an internal short circuit could cause the battery's internal temperature to rise above lithium's melting point (181° C.), which could cause severe flaming.

Some have tried combining polymer electrolytes with lithium metal batteries. Although -Li metal batteries having polymer electrodes have been shown to avoid or substantially avoid dendrite formation, the reported performance of such batteries has not been particularly good. As a result, lithium ion batteries having polymer electrolytes have been the recent focus of development activities for most consumer electronic applications.

Many performance parameters of lithium batteries are associated with the electrolyte choice, and the interaction of the selected electrolyte with the cathode and anode materials used. High electrolyte conductivity leads to improved battery performance. The ionic conductivity of polymer electrolytes have been reported to be as much as approximately 10⁻⁴ S/cm. However, it is desirable for the ionic conductivity of the polymer electrolyte to reach a value of at least approximately 10⁻³ S/cm for many battery applications. In addition, it would also be desirable to enhance the electrochemical stability of the polymer electrolyte towards anode and cathode materials to improve battery reliability, as well as storage and cycling characteristics.

### SUMMARY OF THE INVENTION

A polymer electrolyte includes a modified polymeric material, the modified polymeric material including a halogen containing polymer having an enhanced halogen level. The enhanced halogen level is relative to a halogen content of the halogen containing polymer formed from polymerization of its monomer. The modified polymer electrolyte has an increased amorphous portion compared with initial polymer material. The polymer electrolyte also includes a salt of an alkali metal and an aprotic solvent, where the salt and the aprotic solvent are integrated with the modified polymeric material.

The polymer electrolyte formed from the modified polymeric material can improve the ionic conductivity of the polymer electrolyte material and can also improve the stability of lithium batteries having polymer electrolytes. The invention is applicable to both primary and rechargeable lithium batteries, Li metal or Li ion batteries, the polymer electrolyte being either solid or gel polymer types.

The halogen containing polymer can be at least one chlorine containing polymer, the chlorine containing polymer preferably being polyvinylchloride (PVC). The PVC used is generally a powdered product, which can then be halogenated. PVC can be suspension PVC or emulsion PVC.

There are two main methods for obtaining powdered polyvinylchloride. Suspension polymerization in water of the monomer ethylene chloride (vinyl chloride) or emulsion polymerization in water of the same monomer. The suspension and emulsion processes result in different PVC products. Specifically, suspension and emulsion polyvinylchlorides differ in granylometric composition and certain physical and chemical properties. Accordingly, resulting properties of halogenated PVC (e.g. chlorinated PVC) can depend significantly on the type of initial PVC material (emulsion or suspension PVC) which is subjected to halogenation. The modified polymeric material can comprise chlorinated PVC (C-PVC) having 60-72 wt % chlorine. The polymer electrolyte based on C-PVC can comprise 10-40 wt % C-PVC.

The alkali metal salt can be LiClO₄, LiBF₄, LiAsF₆, LiPF₆, LiCF₃SO₃ or LiN(CF₃SO₂)₂. The electrolyte can comprise from 3-20 wt % of the alkali metal salt.

The aprotic solvent can be propylene carbonate, ethylene carbonate, dimethyl carbonate, gamma-butyrolactone, 1,3-dioxolane or dimethoxyethane. The polymer electrolyte can comprise 40-82 wt % of aprotic solvent.

A rechargeable battery includes an anode containing an alkali metal, a cathode, and a polymer electrolyte formed from a modified polymeric material, the modified polymeric material including a halogen containing polymer having an enhanced halogen level. The enhanced halogen level is relative to a halogen content of the halogen containing polymer formed from polymerization of its monomer. The rechargeable battery includes a salt of an alkali metal and an aprotic solvent, the salt and the aprotic solvent integrated with the modified polymeric material.

The halogen containing polymer can comprise at least one chlorine containing polymer, the modified polymeric material preferably being chlorinated polyvinylchloride (C-PVC).

The battery can be a lithium-ion type, having an anode formed from a lithium containing material, such as lithium ions interleaved with carbon layers. The battery can also be a lithium metal battery have an anode formed from either lithium metal or lithium metal alloy. Lithium alloys can be lithium-aluminum, lithium-aluminum-silicon, lithium-aluminum-cadmium, lithium-aluminum-bismuth or lithium-aluminum-tin.

The cathode can be a metal oxide material, such as a lithium-transition metal oxide material. The cathode can be MnO₂, LiMn₂O₄, vanadium oxides (VₓO_{y}), and other materials such as metal sulfides (e.g. TiS₂), S, polysulphides, polyviologen, polyacetylene, polypyrrole and polythiophene.

A polymer includes a modified polymeric material, the modified polymeric material including a halogen containing polymer having an enhanced halogen level. The enhanced halogen level is relative to a halogen content of the halogen containing polymer formed from polymerization of its monomer.

A method for preparing solid polymer electrolytes includes the steps of providing a halogen containing polymer, halogenating the halogen containing polymer, wherein an enhanced halogen containing modified polymer material results. The enhanced halogen level is relative to a halogen content of the halogen containing polymer formed from polymerization of its monomer. The modified polymer material, at least one salt of an alkali metal and at least one aprotic solvent are then blending together.

The halogen containing polymer can include at least one chlorine containing polymer, such as polyvinylchloride (PVC). Samples of powdered polyvinylchloride can be obtained by suspension polymerization of vinylchloride or emulsion polymerization of the same. The PVC can be subjected a halogenation process, such as chlorination. PVC can be chlorinated by a process of homogeneous or heterogeneous chlorination to form chlorinated polyvinylchloride (C-PVC).

The blending step can include the addition of a volatile solvent. In this case, the method can include the step of removing the volatile solvent, such as by vacuum processing at room temperature.

### BRIEF DESCRIPTION OF THE DRAWINGS

A fuller understanding of the present invention and the features and benefits thereof will be accomplished upon review of the following detailed description together with the accompanying drawings, in which:

FIG. 1 illustrates the temperature dependence ionic of conductivity of a solid polymer electrolyte (SPE) formed from chlorinating a polyvinylchloride polymer (PVC) to form chlorinated polyvinylchloride (C-PVC).

FIG. 2 illustrates the resistivity of the passivating layer formed on a Li electrode surface of a Li-SPE-MnO₂ system, from SPEs based on PVC and C-PVC.

FIG. 3 illustrates the system impedance of a Li-SPE-Li system, the SPE formed from PVC.

FIG. 4 illustrates the impedance of a Li- SPE-Li system, the SPE formed from C-PVC.

FIGS. 5a and 5b illustrate charge and discharge characteristics, respectively, of a Li battery system.

FIGS. 6a and 6b illustrate charge and discharge characteristics, respectively, of a Li battery system.

FIG. 7 illustrates the discharge capacity as a function of the number of charge/discharge cycles for a Li battery system.

FIG. 8 illustrates the discharge capacity as a function of the number of charge/discharge cycles for a Li battery system.

FIG. 9 illustrates respective IR-spectra for PVC and C-PVC evidencing structural differences between PVC and C-PVC.

### DETAILED DESCRIPTION OF THE PREFERRED EMBODIMENTS

Improved lithium batteries having solid polymer electrolytes (SPE) can be formed with using improved polymer electrolyte materials. In one aspect of the invention, a halogen containing polymer electrolyte material is chemically modified by a process of halogenation to raise the halogen content of the polymer. The modification process can improve the ionic conductivity of the polymer electrolyte material and can also improve the stability of lithium batteries having polymer electrolytes. The invention is applicable to both primary and rechargeable lithium batteries, Li metal or Li ion batteries, the polymer electrolyte being either solid or gel polymer types.

In a preferred embodiment of the invention, polyvinylchloride (PVC) is used as the polymer material. Polyvinylchloride is a partially crystalline material with a crystalline percentage of approximately 10%. By chemically modifying the structure of PVC by halogenation, the crystalline portion of the PVC is substantially eliminated. As a result of the modification, the electrochemical stability of the SPE formed from halogenated PVC can be increased resulting in decreased electrolyte reactivity towards the lithium containing anode as well as to many common cathode materials. Decreased electrolyte reactivity reduces the resistivity of passivating films which form on electrode surfaces (e.g. Li metal electrode), and results in improved Li batteries having reduced internal resistance, both during operation and storage life. The chemical modification process can also improve battery performance by increasing the Li ion conductivity of the SPE.

One method of improving the properties of some SPE materials is by a process of halogenation, so that the halogen content of the resulting chemically altered polymer is substantially above the halogen content of the polymer formed from the polymerization reaction. For example, the halogen content of PVC formed from the polymerization of the monomer ethylene chloride (vinyl chloride) is approximately 58.4 wt. %, the halogen content being supplied by the halogen chlorine.

As used herein, electrolytes based on PVC having additional chlorine content over the chlorine level of the polymer formed from polymerization of the monomer ethylene chloride (vinyl chloride) is termed as “chlorinated PVC” or C-PVC, while the addition of other halogens such as F, Br or I to PVC to result in a halogen content above the level of halogen in PVC results in the formation of a polymer herein termed “halogenated PVC”.

Chlorinated PVC has been shown to permit the formation of primary and rechargeable lithium batteries, for both the lithium ion and lithium metal types, having improved efficiency, reliability and enhanced cycling capability and storage stability. The invention is expected to be applicable to other halogen containing polymers and copolymers naturally having significant levels of crystallinity to permit the formation of improved SPE lithium batteries from these polymers.

Specifically, it has been demonstrated that the electrochemical properties of PVC for application in SPE lithium batteries for both the lithium ion and lithium metal types can be significantly improved by providing additional halogen in the form of chlorine to PVC, the additional halogen relative to the chlorine content of PVC formed from polymerization of the monomer ethylene chloride (vinyl chloride) (approximately 58.4 wt. %). By adding additional chlorine to PVC, it has been found that the PVC material can be modified both chemically and structurally. During chlorination, the crystalline portion of PVC is largely eliminated leading to an increase in its amorphous portion. With an increase in the amount of chlorine to at least approximately 60%, and preferably 60 to 75%, to form chlorinated PVC (C-PVC), the resulting C-PVC polymer also acquires an improved solubility in a variety of organic solvents, such as acetone-toluene or acetone-toluene-butylacetate types.

Polymer electrolytes formed using the invention include a halogen containing polymer having an enhanced halogen level, the modified polymer having enhanced halogen level relative to the halogen content of the polymer resulting from polymerization of the applicable monomer. A salt of an alkali metal and an aprotic solvent are preferably intermixed with the modified polymer. Preferably, the polymer electrolyte contains 10-40 wt % of the halogen comprising modified polymer.

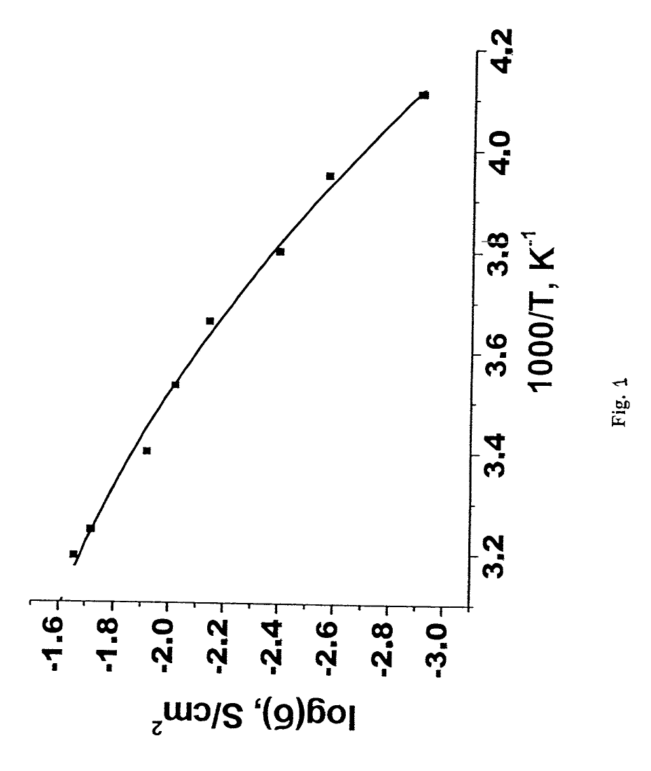

Chlorinated PVC leads to a polymer having properties distinct from the polymer PVC. The combination of C-PVC polymer and an alkali metal salt and aprotic solvent has been shown to produce a SPE having a high ionic conductivity. As shown in FIG. 1, the room temperature ionic conductivity per unit area of C-PVC at 25° C. (300 K) is greater than 0.01 S/cm² for an SPE having the composition C-PVC:PC:LiClO₄ (15.6:77.9:6.5 wt %). FIG. 1 also illustrates the temperature dependence of ionic conductivity of the same SPE.

The invention is applicable to a broad range of alkali metal salts, aprotic solvents and electrode materials. Preferably, alkali metal salts are chosen from LiClO₄, LiBF₄, LiAsF₆, LiPF₆, LiCF₃SO₃ and LiN(CF₃SO₂)₂. The alkali metal salt is preferably 3-10 wt % of SPE.

The aprotic solvent is preferably selected from propylene carbonate, ethylene carbonate, dimethyl carbonate, gamma-butyrolactone, 1,3-dioxolane, and dimethoxyethane. The aprotic solvent is preferably 40-82 wt % of the SPE.

Both primary and rechargeable batteries formed from either lithium ion or lithium metal cells having a SPE, can be formed using the invention. According to the invention, A Li battery cell includes an anode containing an alkali metal, a cathode and a polymer electrolyte interposed between the anode and cathode, the polymer electrolyte formed from a halogenated polymer material. A salt of an alkali metal and an aprotic solvent are preferably intermixed with the halogenated polymer to form a polymer matrix material, the polymer matrix material including an alkali salt and an aprotic solvent.

In a preferred embodiment, a lithium metal battery having a SPE is formed. In this embodiment, the anode can be formed from lithium metal or a lithium alloy. Lithium alloys include lithium-aluminum, lithium-aluminum-silicon, lithium-aluminum-cadmium, lithium-aluminum-bismuth, lithium-aluminum-tin. The lithium content in these lithium alloys is preferably in the range from 75-85 wt %.

The cathode material is preferably selected from MnO₂, V_{y}Oₓ, lithium transition metal oxides, such as LiₓMn_{y}O_{z} (e.g. LiMn₂O₄), LiCoO₂, LiNiO₂, and other materials such as metal sulfides (e.g. TiS₂), S, polysulphides, polyviologen, polyacetylene, polypyrrole and polythiophene.

Polyvinyl chloride has not been used as an SPE material for Li batteries for a number of reasons. First, PVC is known to include a crystalline phase portion, where the overall degree of crystallinity is approximately 10%. Crystalline polymer regions generally result in degraded Li ion conductivity and reduced polymer solubility in organic solvents. Poor solubility in organic solvents complicates preparation of gel-polymer electrolytes using such a polymer.

Polyvinylchloride is also known to be highly reactive towards lithium which can lead to the formation of passivating films having high resistivity on the lithium electrode surface. A highly resistive passivating layer on the Li electrode surface can significantly degrade the performance of the lithium battery by adding significant series resistance, degrading performance, and particularly degrading the cycling properties of the battery.

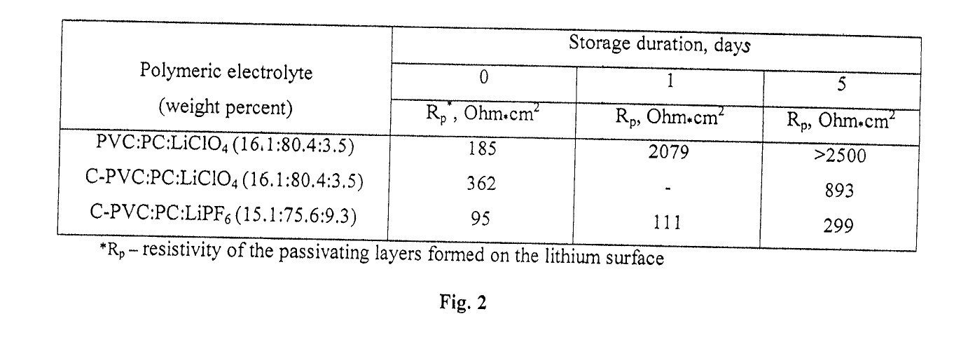

As shown in FIG. 2, the resistivity of the passivating layer (Rp) formed on the Li electrode surface generally increases over time. However, the parameter Rp is seen to be substantially higher for a lithium electrode with PVC as compared lithium electrodes with C-PVC (having 61.4 wt. % Cl). Increasing Rp adds internal series resistance to a battery. High Rp corresponds to increased Li reactivity with the SPE, while lower Rp corresponds to diminished Li reactivity with the SPE.

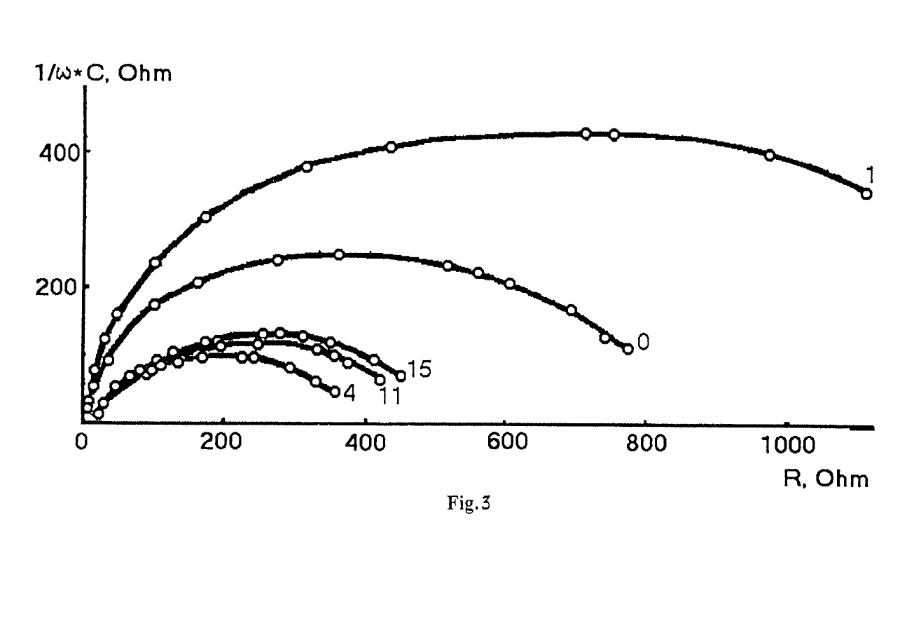

FIG. 3 shows the impedance of a Li-SPE-Li system. The SPE was formed from PVC, a propylene carbonate (PC) solvent and LiClO₄ salt, the SPE having a composition PVC:PC:LiClO₄ (15.6:77.9:6.5 wt %). The system impedance characteristics were measured as a function of storage time of the system. The impedance system parameters (resistance and capacitance) were determined by forcing an alternating current over a wide frequency range, from 0.08 to 200 kHz. The y-axis parameter is shown having units 1/ωC, 1/ωC being the imaginary part of the system impedance (reactive impedance), where ω is the angular frequency. Each curve corresponds to a storage time in days, demonstrating impedance aging characteristics of the system.

The system impedance data shown in FIG. 3 characterizes not only the SPE located between the two lithium electrodes, but also the properties of the electrode interfaces, such as the lithium electrode/polymer electrolyte interface. The properties of the lithium-polymer electrolyte interface are very important for a lithium power source.

The interface properties substantially determine many important battery characteristics.

For example, power source safety during its storage, resistance of passivating film formed on the lithium surface (Rp) and resulting power source internal series resistance, and power source charging cycling efficiency are strongly influenced by interface properties.

The properties of the lithium electrode/polymer electrolyte depend on chemical reactions which can occur over time between the active lithium electrode and the various components of polymer electrolyte. As a result of chemical interactions which occur on the lithium electrode surface, passivating resistive film are generally formed and lithium corrosion takes place. Thus, a polymer electrolyte such as C-PVC, which can reduce the reactivity of the SPE towards the Li electrode can improve Li battery performance.

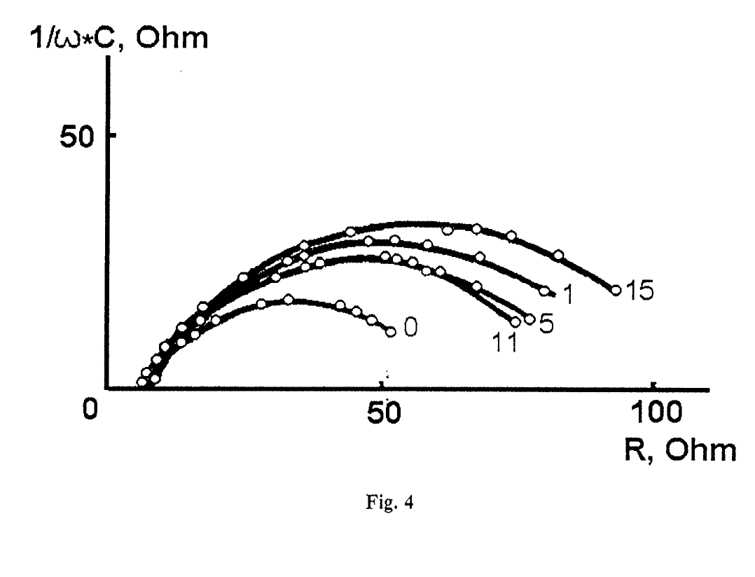

FIG. 4 illustrates the impedance of a Li-SPE-Li system according to an embodiment of the invention having a SPE composition for the system shown in FIG. 3, except that C-PVC polymer having 61.4 wt % Cl was substituted for PVC. The electrolyte structure used was C-PVC: PC:LiClO₄ (15.6:77.9:6.5 wt %). Comparing the system impedance results between FIGS. 4 (C-PVC) and FIG. 3 (PVC), it can be seen the system impedance for both resistive and capacitive reactive components is significantly improved by substituting C-PVC for PVC. The improvement can be attributed to formation of a passivating layer with lower resistivity in the case of C-PVC (FIG. 4) as compared to the passivating layer formed when PVC (FIG. 3) is used. This point was noted with respect to FIG. 2 with regard to the reduced reactivity of lithium towards C-PVC as compared to the reactivity of lithium with PVC.

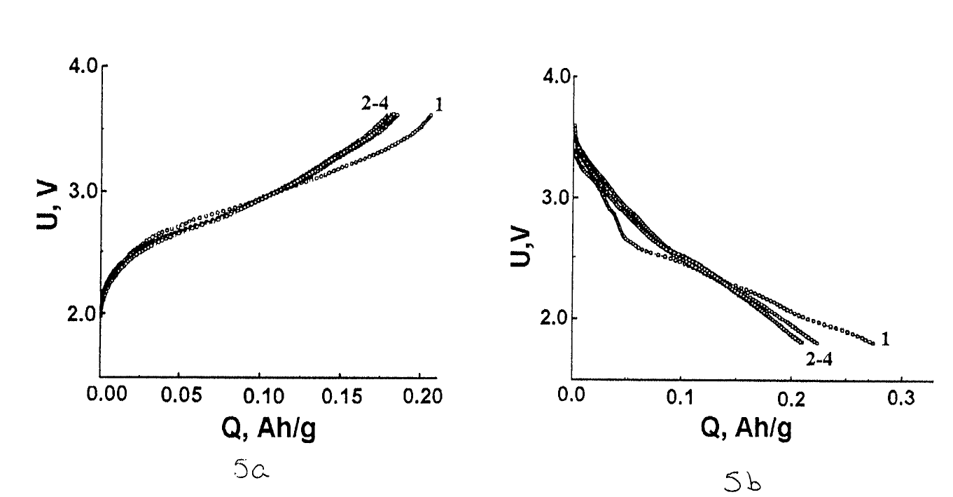

Lithium batteries formed using C-PVC based electrolytes using the invention also provide high electrochemical stability including good stability during long-term cycling as shown in FIGS. 5-8. FIGS. 5a and 5b illustrate charge and discharge characteristics, respectively, of a Li/SPE/V₆O₁₃ system within a 2325 coin cell having a polymer electrolyte: C-PVC (61.4 wt % Cl):PC:LiClO₄ (15.6:77.9:6.5 wt %). I_{charge}=I_{discharge}=100 μA/cm², V₆O₁₃ mass=2.5 mg/cm²). The x-axis represents system capacity measured in Ah/g, while the y-axis represents cell voltage.

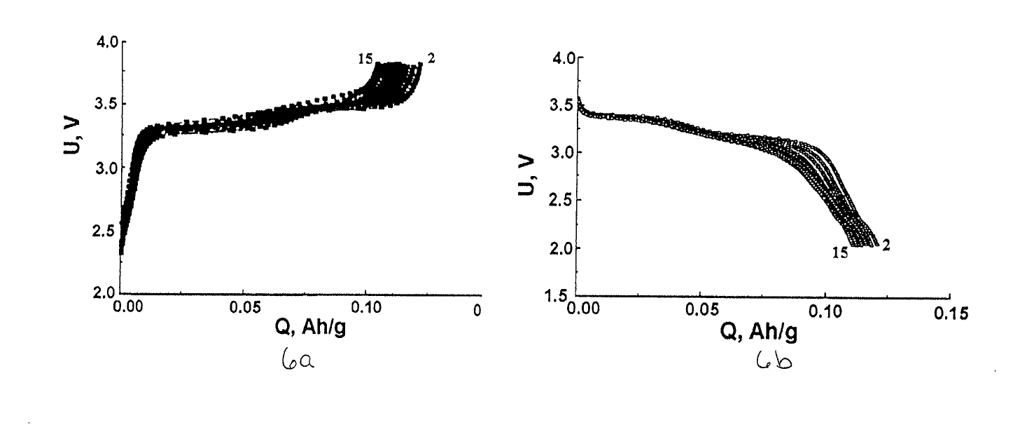

FIGS. 6a and 6b illustrate charge and discharge characteristics, respectively, of Li battery system including an SPE, according to another embodiment of the invention. The system used was a Li/SPE/V₂O₅ system within a 2325 coin cell having a SPE of the composition: C-PVC (61.4 wt % Cl):PC:LiClO₄ (15.6:77.9:6.5 wt %). I_{charge}=I_{discharge}=50 μA/cm², V₂O₅ mass=2.3 mg /cm².

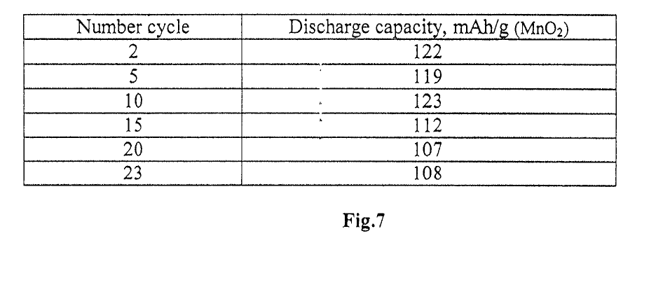

FIG. 7 illustrates battery discharge capacity as a function of the number of charge/discharge cycles for a Li battery system, according to an embodiment of the invention. The system used was a Li/SPE/MnO₂ cathode with a SPE of composition C-PVC (61.4 wt % Cl):PC:LiClO₄ (15.6:77.9:6.5 wt %). The system capacity can be seen to be quite stable after 23 cycles.

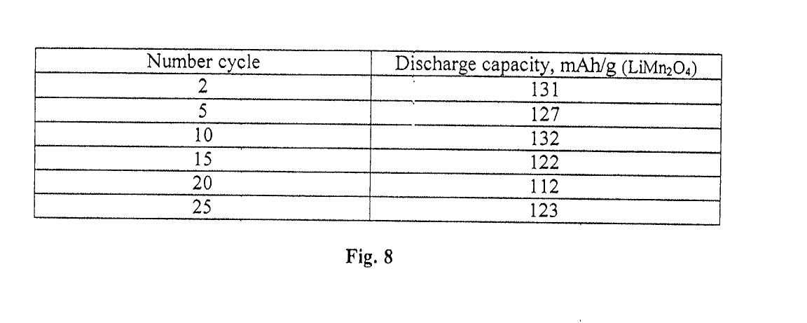

FIG. 8 illustrates battery discharge capacity as a function of the number of charge/discharge cycles for a Li battery system, according to an embodiment of the invention. The system used was a Li/SPE/LiMn₂O₄ with a SPE having the composition: C-PVC (61.4 wt % Cl):PC:LiClO₄ (15.6:77.9:6.5 wt %). The system capacity can be seen to be quite stable after 25 cycles.

A halogen containing polymer having significant levels of crystallinity may be halogenated in a manner described with respect to the halogenation by chlorination of PVC. The formation of a C-PVC SPE can be accomplished by the following method. In a first step, PVC is chlorinated either heterogeneously (e.g. in H₂O or CCl₄) or homogenously (in organic solvents) at a temperature of approximately 80° C. in the presence of a reaction initiator, such as 2,2′ azo-bis-isobutyronitrile. There are two main production methods for obtaining chlorinated PVC, heterogeneous chlorination and homogeneous chlorination. Under heterogeneous chlorination, gaseous chlorine (Cl₂) is passed through a suspension of powdered polyvinylchloride in liquids, such as water or CCl₄. Under homogeneous chlorination, gaseous chlorine is passed through polyvinylchloride in a solution of one or more organic solvents.

The C-PVC formed can then combined with LiClO₄ and propylene carbonate which are together dissolved in tetrahydrofuran (THF) to form a substantially homogenous solution. This solution is then casted upon a glass sheet or placed directly on the electrode and dried 24 hours at room temperature and then for 48 hours under a vacuum at 45° C. After drying the thin C-PVC SPE film, the film is ready for use in lithium batteries.

The operating properties of C-PVC polymeric electrolytes depend to a large extent on the degree of chlorination and on the composition of the electrolyte. High conductivity as well as good electrochemical and chemical stability during storage was shown by SPE electrolytes containing 10-40 wt % C-PVC, where the C-PVC had a chlorine content in the range of 60-72 wt %, 40-82 wt % aprotic solvent (such as PC) and 3-20 wt % of a alkali (e.g. lithium) salt.

The invention can be better understood with reference to the following examples:

### EXAMPLE 1

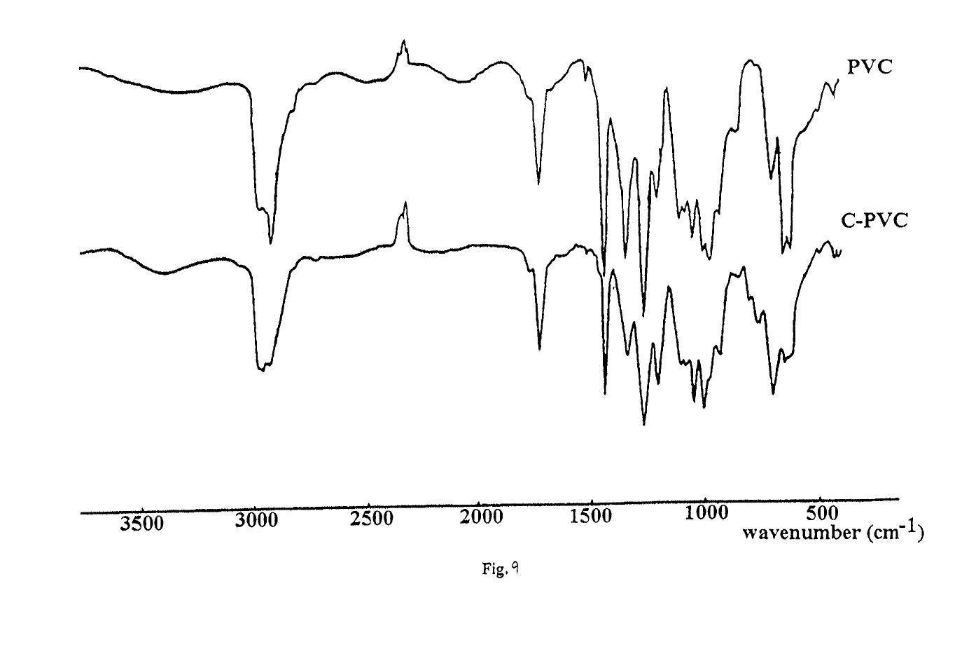

PVC was heterogeneously chlorinated in a chemical flask provided with a mixing device, a reverse cooler and a pipe for introducing a flow of chlorine. Twenty (20) g of PVC, 100 ml tetrachlorocarbon (CCl₄) and 0.2 g of a 2,2′ azo-bis-(isobutyronitrile) reaction initiator were added to a flask. The flask was heated in a silicon bath to 80° C., and then CCl₄ was introduced. At the beginning of the reaction a faint yellow-green color in the liquid appeared. The reaction was carried out during a 2 hour period. The resulting mixture was then filtered through a Shott glass filter. The C-PVC was then rinsed 10 times with warm (boiling) water and 3 times with a 76% aqueous ethanol mixture. The polymer was then dried 18 hours at 60° C. and under vacuum at 40° C. The chlorine content of the chlorinated PVC obtained was measured at 60.5%. The IR-spectra of C-PVC product is shown in FIG. 9. FIG. 9 shows a decrease in the intensity of the absorption band at 2920 cm⁻¹ and 1430 cm⁻¹ of the C-PVC compared to the PVC corresponding to —CH₂— in PVC. Simultaneously, an increase in the absorption band intensity at 2967 cm⁻¹ corresponds to the oscillations of —CH— groups.

Thus, the IR data noted above evidences the following chlorination reaction:

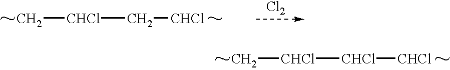

In addition, an analysis of the ratio value between optical density at the wavelength 695 cm⁻¹ and the optical density at 635 cm ⁻¹ related with the oscillation of C-Cl groups within atactic and syndiotactic regions of polymer, respectively is considered to be significant. The D₆₉₅/D₆₃₅ index has been reported as a crystallinity measure of PVC derivatives [S. Krimm, Advances Polymer Sci., 2, 124 (1960)] (see Table 1).

For PVC, the D₆₉₅/D₆₃₅ index has the value of 0.55. For C-PVC, the value of this index is a function of the chlorinating conditions used and the resulting chlorine added to the PVC. The D₆₉₅/D₆₃₅ ratio for C-PVC has been measured to be from 0.74 to 1.33. The higher the value of the D₆₉₅/D₆₃₅ ratio, the more amorphous the polymer is.

### EXAMPLE 2

A mixture of C-PVC (15.6 wt %), the chlorine content of C-PVC being approximately 61.4%, PC (77.9 wt %) and LiClO₄ (6.5 wt %) were dissolved in 520 ml of tetrahydrofuran. A homogenous solution was formed which was then casted upon a glass support. The film was dried for 24 hours at room temperature and then for 48 hours at 45° C. under vacuum. Impedance measurements of a system formed with a pair of Ni electrodes. In order to directly determine a resistance of polymer electrolyte the investigations of the impedance characteristics are derived preferably by using inert electrodes. Such electrodes are selected from electrode materials which do not interact with the components of polymer electrolyte, such as nickel, platinum and steel. Thus, electrode-polymer electrolyte reactions do not occur to any significant degree at the electrode-polymer interfaces. Accordingly, passivating films which can effect the measured impedance characteristics are not formed. Accordingly, measurement of impedance using substantially unreactive electrodes such as Ni allows the direct determination of the resistance of a polymer electrolyte.

The conductivity of the film formed in this example was measured at 25° C. as being 0.045 Sm/cm², where SM/cm² is the conductivity per unit of electrolyte surface area. This conductivity measure is useful for the evaluation of the technological and operational characteristics of comparatively thin materials, such as those less than approximately 100 μm. Such an evaluation of the material properties is convenient in the case when materials are plastic and can readily change their thickness in actual products. For example, the thickness of a polymer electrolyte layer, as well as the thickness of a standard polypropylene separator, can decrease during power source assembly when affected by mechanical compression. During power source operation, the changing thickness of plastic polymer electrolytes (as well as a separator) can occur due to the changing of electrodes thickness in response to pressure applied to the electrolyte.

Therefore, it is convenient to express a specific conductivity per unit of polymer electrolyte surface area. With this measure, properties of a power source having a standard polypropylene separator having liquid electrolyte can be readily compared to the properties of power sources having a given SPE.

Voltage measurements using platinum electrodes showed that the SPE based on C-PVC is stable in the voltage range 0.8-4.5 V. Thus, C-PVC can be used in a wide variety of battery systems having a plurality of different cathode materials.

### EXAMPLE 3

A mixture of C-PVC (15.2 wt %) having 61.4 wt. % Cl, PC (38.0 wt %), ethylene carbonate (EC) (38.0 wt %) and LiPF₆ (8.8 wt %) were dissolved in 520 ml tetrahydrofuran. A homogenous solution formed was casted upon a glass support. The film was dried for 24 hours at room temperature and 48 hours at 45° C. under vacuum. Impedance measurements in a Ni-SPE-Ni system revealed a SPE film conductivity of approximately 0.066 Sm/cm².

### EXAMPLE 4

A mixture of C-PVC (16.1 wt %) having 61.4 wt. % Cl, PC (80.8 wt %) and LiBF₄ (3.1 wt %) was dissolved in 520 ml tetrahydrofuran. A homogenous solution was formed which was casted on a glass support. The film was dried for 24 hours at room temperature and 48 hours at 45° C. under vacuum. Impedance measurements in a Ni-SPE-Ni system revealed a SPE film conductivity of approximately 0.065 Sm/cm².

### EXAMPLE 5

A mixture of C-PVC (15.9 wt %) having 61.4 wt. % Cl, PC (79.3 wt %) and LiCF₃SO₃ (4.8 wt %) were dissolved in 520 ml tetrahydrofuran. A homogenous solution was formed which was then casted on a glass support. The film was dried for 24 hours at room temperature and then 48 hours at 45° C. under vacuum. Impedance measurements in a Ni-SPE-Ni system revealed a SPE film conductivity of approximately 0.032 Sm/cm².

### EXAMPLE 6

A mixture of C-PVC (15.2 wt %) having 61.4 wt. % Cl, PC (60.4 wt. %), DME (17.9 wt %) and LiClO₄ (6.5 wt %) was dissolved in 520 ml tetrahydrofuran. A homogenous solution was formed which was then casted on a glass support. The film was dried for 24 hours at room temperature and 48 hours at 45° C. under vacuum. Impedance measurements in a Ni-SPE-Ni system revealed a SPE film conductivity of approximately 0.108 Sm/cm².

### EXAMPLE 7

A rechargeable battery of the system Li/SPE/V₆O₃ having the size of a 2325 coin cell was prepared by interposing layers of the polymer electrolyte (prepared according to Example 1 and with a thickness of 0.12 mm), metallic lithium anode (thickness 1.8 mm), and a cathode, prepared from a mixture of V₆O₁₃ (85%), carbon black (5%), graphite (5%) and a binder—PVdF 20810 (Solvay) (5 wt %). The battery was cycled at 20° C. between 2.0 and 3.7 V with a current 0.1 mA during discharge and 0.1 mA during charging. The results of these measurements are shown in FIG. 5.

### EXAMPLE 8

A rechargeable battery of the system Li/SPE/V₂O₅ having the size of a 2325 coin cell was prepared by interposing layers of the polymer electrolyte (prepared according to Example 1 with a thickness of 0.12 mm) between a metallic lithium (thickness 1.8 mm) anode and a cathode, prepared from a mixture of V₂O₅ (85%), carbon black (5%), graphite (5 %) and binder PVdF 20810 (Solvay) (5 wt %). The battery was cycled at 20° C. between 2.3 and 3.7 V with a current of 0.05 mA during discharge and 0.1 mA during charging. The results of these measurements are shown in FIG. 6.

### EXAMPLE 9

A rechargeable battery of a system Li/SPE/MnO₂ having the size of a 2325 coin cell was prepared by interposing layers of the polymer electrolyte (prepared according to Example 1 and with a thickness of 0.15 mm) between a metallic lithium anode (thickness 1.8 mm), and a cathode prepared from a mixture of MnO₂ (80 wt %), carbon black (5 wt %), graphite (5 wt %) and a binder, using a suspension of the fluororinated polymer polytetrafluoroethylene (10 wt %). The battery was cycled at 20° C. between 2.0 and 3.7 V with a current 0.1 mA during discharge and 0.02 mA during charging. The results of these measurements are shown in FIG. 7.

### EXAMPLE 10

A rechargeable battery of the system Li-SPE-LiMn₂O₄ having the size of a 2325 coin cell was prepared by interposing layers of the polymer electrolyte (prepared according to Example 1 and with a thickness of 0.15 mm) between a metallic lithium anode (thickness 1.8 mm), and a cathode prepared from a mixture of LiMn₂O₄ (80 wt %), carbon black (5 wt %), graphite (5 wt %) and a binder, using a suspension of the fluorinated polymer polytetrafluoroethylene (10 wt %). The battery was cycled at 20° C. between 2.0 and 3.7 V with a current of 0.1 mA during discharge and 0.02 mA during charging. The results of these measurements are shown in FIG. 8.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

We claim:

1. A polymer electrolyte comprising:
a modified polymeric material, said modified polymeric material including a halogen containing polymer having an enhanced halogen level, said enhanced halogen level relative to a halogen content of said halogen containing polymer formed from polymerization of its monomer;
a salt of an alkali metal; and
an aprotic solvent, wherein said salt and said aprotic solvent are integrated with said modified polymeric material.

2. The polymer electrolyte of claim 1, wherein said halogen containing polymer includes at least one chlorine containing polymer.

3. The polymer electrolyte of claim 2, wherein said chlorine containing polymer is polyvinylchloride (PVC).

4. The polymer electrolyte of claim 3, wherein said polyvinylchloride (PVC) is suspension polyvinylchloride (PVC).

5. The polymer electrolyte of claim 3, wherein said polyvinylchloride (PVC) is emulsion polyvinylchloride (PVC).

6. The polymer electrolyte of claim 1, wherein said modified polymeric material comprises C-PVC, said C-PVC having 60-72 wt % chlorine.

7. The polymer electrolyte of claim 6, wherein said polymer electrolyte comprises 10-40 wt % of said C-PVC.

8. The polymer electrolyte of claim 1, wherein said alkali metal salt is at least one selected from the group consisting of LiClO₄, LiBF₄, LiAsF₆, LiPF₆, LiCF₃SO₃ and LiN(CF₃SO₂)₂.

9. The polymer electrolyte of claim 1, wherein said electrolyte comprises from 3-20 wt % of said salt of an alkali metal.

10. The polymer electrolyte of claim 1, wherein as said aprotic solvent is at least one selected from the group consisting of propylene carbonate, ethylene carbonate, dimethyl carbonate, gamma-butyrolactone, 1,3-dioxolane and dimethoxyethane.

11. The polymer electrolyte of claim 1, wherein said electrolyte comprises 40-82 wt % of said aprotic solvent.

12. A rechargeable battery, comprising:
an anode containing an alkali metal;
a cathode; and
a polymer electrolyte formed from a modified polymeric material, said modified polymeric material including a halogen containing polymer having an enhanced halogen level, said enhanced halogen level relative to a halogen content of said halogen containing polymer formed from polymerization of its monomer, a salt of an alkali metal and an aprotic solvent, wherein said salt and said aprotic solvent are integrated with said modified polymeric material.

13. The rechargeable battery of claim 12, wherein said halogen containing polymer comprises at least one chlorine containing polymer.

14. The rechargeable battery of claim 13, wherein said modified polymeric material comprises chlorinated polyvinylchloride (C-PVC).

15. The rechargeable battery of claim 12, wherein in said anode comprises lithium.

16. The rechargeable battery of claim 12, wherein said anode comprises a lithium alloy.

17. The rechargeable battery of claim 16, wherein as said lithium alloy is at least one selected from the group consisting of lithium-aluminum, lithium-aluminum-silicon, lithium- aluminum-cadmium, lithium-aluminum-bismuth and lithium-aluminum-tin.

18. The rechargeable battery of claim 12, wherein said anode comprises a lithium-ion material.

19. The rechargeable battery of claim 12, wherein said cathode comprises a metal oxide.

20. The rechargeable battery of claim 12, wherein said cathode comprises a lithium-transition metal oxide.

21. The rechargeable cell of claim 12, wherein said cathode is at least one selected from the group consisting of MnO₂, LiMn₂O₄ and vanadium oxides (VₓO_{y}).

22. The rechargeable cell of claim 12, wherein said cathode comprises a organic polymer.

23. The rechargeable cell of claim 12, wherein said cathode is at least one selected from the group consisting of polyviologen, polyacetylene and polypyrrole.

24. The rechargeable cell of claim 12, wherein said cathode comprises a sulfur containing material.

25. The rechargeable cell of claim 12, wherein said cathode is at least one selected from the group consisting of TiS₂, S, polysulphide and polythiophene.

26. A polymer comprising:
a modified polymeric material, said modified polymeric material including a halogen containing polymer having an enhanced halogen level, said enhanced halogen level relative to a halogen content of said halogen containing polymer formed from polymerization of its monomer.

27. A method for preparing solid polymer electrolytes, comprising the steps of:
providing a halogen containing polymer;
halogenating said halogen containing polymer, wherein an enhanced halogen containing modified polymer material results, said enhanced halogen level relative to a halogen content of said halogen containing polymer formed from polymerization of its monomer;
blending together said modified polymer material, at least one salt of an alkali metal and at least one aprotic solvent.

28. The method of claim 27, wherein said halogen containing polymer comprises at least one chlorine containing polymer.

29. The method of claim 28, wherein said chlorine containing polymer comprises polyvinylchloride (PVC).

30. The method of claim 29, wherein said polyvinylchloride (PVC) is suspension polyvinylchloride (PVC).

31. The method of claim 29, wherein said polyvinylchloride (PVC) is emulsion polyvinylchloride (PVC).

32. The method of claim 27, wherein said modified polymeric material comprises chlorinated polyvinylchloride (C-PVC).

33. The method of claim 32, wherein said halogenation comprises chlorination, said PVC being chlorinated by a process of homogeneous or heterogeneous chlorination.

34. The method of claim 27, wherein said blending step includes comprises addition of a volatile solvent.

35. The method of claim 34, further comprising the step of removing said volatile solvent.

36. The method of claim 35, wherein said removing step comprises vacuum processing at room temperature.
